(19) United States
(12) Patent Application Publication
(10) Pub. No.: US 2005/0206693 A1
(43) Pub. Date: Sep. 22, 2005

(54) High capacity ink supply apparatus

(76) Inventor: Stephen Chen, Shengang Shiang (TW)

Correspondence Address: BRUCE H. TROXELL, SUITE 1404, 5205 LEESBURG PIKE, FALLS CHURCH, VA, 22041, US

(21) Appl. No.: 10/805,270

(22) Filed: Mar. 22, 2004

(51) Int. Cl. B41J 2/175

(52) U.S. Cl. 347/85; 347/86

(57) ABSTRACT

A high capacity ink supply apparatus and particular an ink supply apparatus for inkjet printers mainly includes a high capacity tank, a duct and an ink cartridge. The high capacity tank has an air intake device to receive air and a check valve to allow the ink to flow in one direction. The ink cartridge is formed in a standardized fashion to be housed in a core trough of an imitated outer cartridge which is compatible with the original ink cartridge of a corresponding brand. Such a structure can increase ink storage capacity and reduce ink utilization cost and improve the applicability for various brands.

### BACKGROUND OF THE INVENTION

1. Field of the Invention

The invention relates to a high capacity ink supply apparatus and particularly to a high capacity ink supply apparatus for inkjet printers to overcome the problems of limited ink capacity and high prices of ink cartridges used in the existing inkjet printers.

2. Description of the Prior Art

Digital camera has become increasingly popular these days. Users can print photos at home by themselves. As a result, printers, especially color printers, are widely used. The ink for printing the photos also is consumed quickly. The present ink cartridges usually have limited capacity. They have to be replaced frequently. It is not convenient. Moreover, the ink cartridge is quite expensive. To remedy this problem, A R.O.C. patent publication no. 538909 (called “the reference” hereinafter) discloses an ink supply device that provides a greater ink capacity. However, that device has drawbacks during installation and use, notably:
1. During transportation or not in use, the ink could flow reversely and air could enter the duct due to siphonage and result in interruption of ink supply during printing. When not in use, the duct has to be clamped by a clip to prevent reverse flow or flow interruption of the ink.

2. In the reference, the duct is extended upwards to the storage tank. The ink in the storage tank cannot be fully depleted and use. It results in waste of the ink.

### SUMMARY OF THE INVENTION

In view of the aforesaid disadvantages, the primary object of the present invention is to provide a high capacity ink supply apparatus for inkjet printers to overcome the problem of ink supply limitation occurred to the conventional ink cartridges, and also to reduce the cost of ink usage and alleviate the inconvenience of frequently replacing the ink cartridge.

Another object of the invention is to provide a high capacity ink supply apparatus with a standardized ink cartridge so that the standardized ink cartridge may be inserted into a core trough of an imitated outer cartridge which is formed with a profile matching the original ink cartridge of a corresponding brand thereby the fabrication cost of the ink cartridge may be reduced and the applicability of the invention may increase.

In order to achieve the foregoing objects, the high capacity ink supply apparatus according to the invention mainly includes a high capacity tank, a duct and an ink cartridge. The high capacity tank includes an air intake device for receiving air and a check valve to allow the ink to flow in one direction. The apparatus thus constructed can increase ink storage capacity and reduce the cost of ink usage.

The high capacity ink supply apparatus according to the invention further has a standardized ink cartridge to be inserted into a core trough of an imitated outer cartridge which is formed with a profile matching the original ink cartridge of a corresponding brand thereby the ink storage capacity may increase, ink usage cost may be reduced and the applicability to various brands may increase.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of an embodiment of the invention.

FIG. 2 is a perspective view of an embodiment of the invention.

FIG. 3 is a sectional view of a first dock cavity and the air intake device of the invention.

FIG. 4 is a sectional view of a second dock cavity and the check valve of the invention.

FIG. 5 is a sectional view of the ink outflow device of the invention.

FIG. 6 is a schematic view of another embodiment of the invention showing the high capacity tank equipped with an air inlet.

FIG. 7 is an exploded view of the invention showing the ink cartridge and an imitated outer cartridge.

FIG. 8 is a cross section of yet another embodiment of the invention.

FIG. 9 is a schematic view of another embodiment of the invention showing the ink cartridge and the imitated outer cartridge coupled together.

FIG. 10 is a schematic view of yet another embodiment of the invention showing the ink cartridge and the imitated outer cartridge coupled together.

### DESCRIPTION OF THE PREFERRED EMBODIMENTS

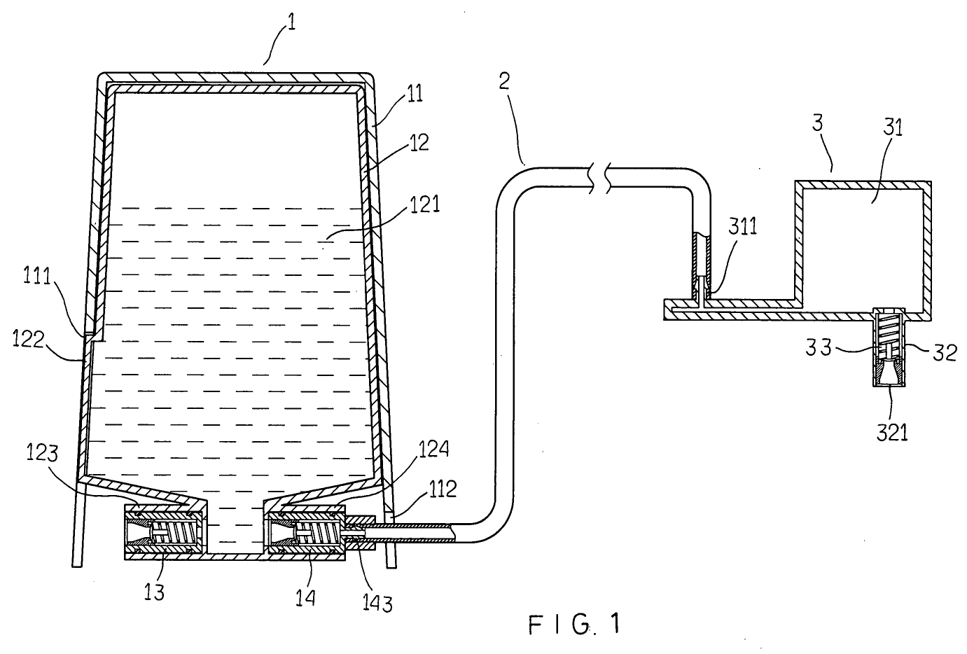

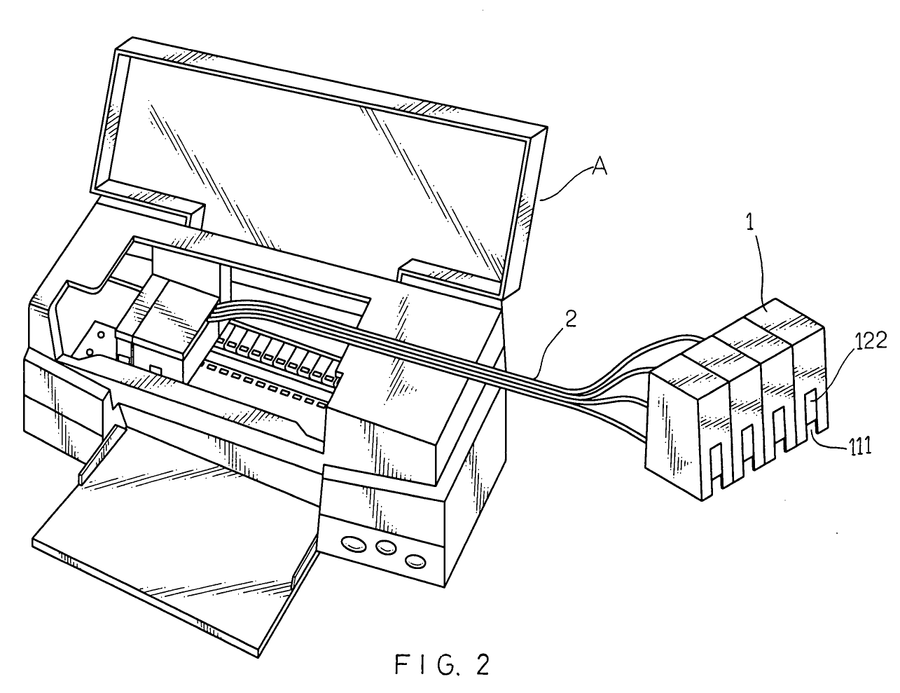

Referring to FIGS. 1 and 2, the high capacity ink supply apparatus according to the invention mainly includes a high capacity tank 1, a duct 2 and an ink cartridge 3. The high capacity tank 1 is connected to the ink cartridge 3 through the duct 2.

The high capacity tank 1 has a closed container 12 for holding ink 121. It includes an air intake device 13 for receiving air and a check valve 14 to allow the ink to flow in one direction. The air intake device 13 is located in a first dock cavity 123 on one side at the bottom of the closed container 12. The check valve 14 is located in a second cavity 124 on another side thereof. The check valve 14 has an outlet end to couple with a duct connector 143 which is connected to one end of the duct 2.

The duct 2 is a hollow tube.

The ink cartridge 3 may be held in an ink cartridge housing of an inkjet printer A. It has an ink chamber 31 which has one side extended to form a duck connector 311 to connect one end of the duct 2. It further includes an ink outflow device 32 on a lower side corresponding to an ink supply duck 5 of the nozzle of the inkjet printer for the ink to flow out in one direction (referring to FIG. 5).

The closed container 12 of the high capacity tank 1 is made from a transparent material (such as plastics, glass, or the like). It has an extension 122 on one side of a lower section to couple with an outer casing 11 made from opaque material (such as colored plastics). The outer casing 11 has an opening 111 corresponding to the extension 122 and a bore 112 to allow the duct 2 to run through. The outer casing 11 may be coupled on the outer periphery of the closed container 12. The extension 122 forms a window allowing users to see the storing level of the ink 121.

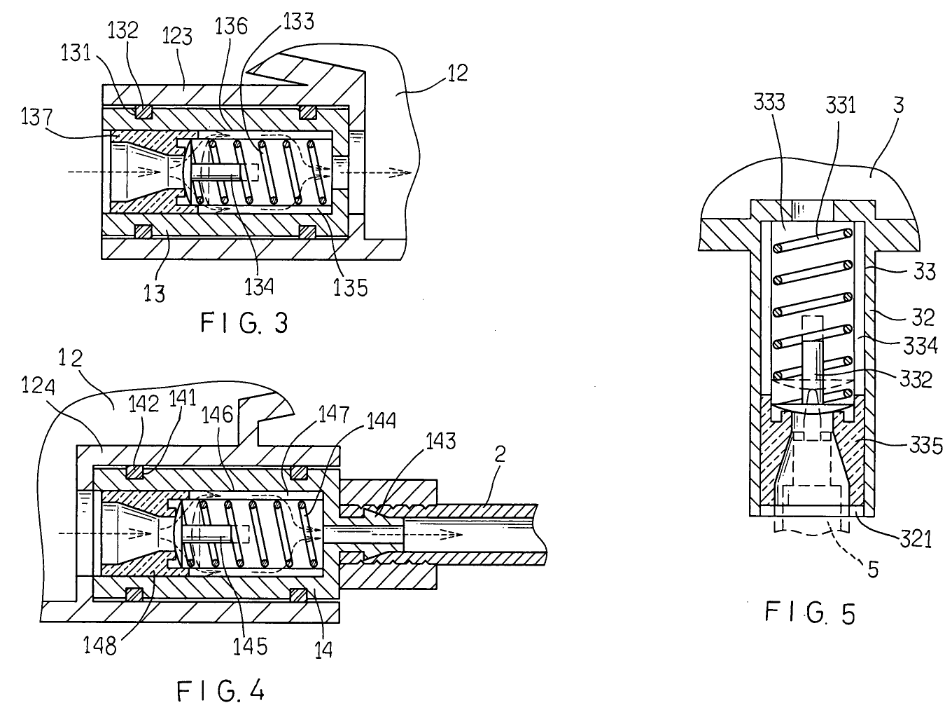

The air intake device 13 located in the first dock cavity 123 of the closed container 12 may be a check valve (referring to FIG. 3) to allow air to enter the closed container 12 so that the air can replenish the void space when the ink 121 is used and diminished to balance the internal pressure of the closed container 12. Moreover, the air intake device 13 has one or more annular leak-proof groove 131 formed on the outer periphery to couple with a leak-proof ring 132. The air intake device 13 also has a housing chamber 136 to house a spring 133 and a leak-proof plug 134. The housing chamber 136 has a plurality of channeling flutes 135 on a side wall and anther side coupled with a plug 137 which has a conical aperture formed thereon. The check valve 14 located in the second dock cavity 124 (referring to FIG. 4) allows the ink 121 in the closed container 12 to be sucked and flow out when the inkjet printer A is printing. The ink 121 flows into the ink cartridge 3 through the duct 2 and is prevented from flowing back. The check valve has at least one annular leak-proof groove 141 on the outer periphery to couple with a leak-proof ring 142. The check valve 14 has one end coupling with a duct connector 143 and a housing chamber 146 to house a spring 144 and a leak-proof plug 145. The housing chamber 146 has a plurality of channeling flutes 147 on a side wall and anther side coupled with a plug 148 which has a conical aperture formed thereon.

The ink cartridge 3 has an ink outflow device 32 to enable the ink 121 contained in the ink cartridge 3 to flow to an ink supply duct 5 of a nozzle of the inkjet printer A. The ink outflow device 32 has a check valve 33 (referring to FIG. 5) which has a housing chamber 333 to house a spring 331 and a leak-proof plug 332. The housing chamber 333 has a plurality of channeling flutes 334 on an upper side wall and a lower section coupled with a plug 335 which has a conical aperture formed thereon.

By means of the construction set forth above, the high capacity tank 1 and the ink cartridge 3 are connected through the duct 2. The ink cartridge 3 is inserted in an ink cartridge housing (not shown in the drawings) of the inkjet printer A. The ink outflow device 32 of the ink cartridge 3 coupled with the ink supply duct 5 of the inkjet printer A. When the inkjet printer is operating, a suction force will be generated to draw the ink 121 contained in the ink cartridge 3 to the nozzle of the inkjet printer for ejection. Thus the ink 121 in the closed container 12 will continuously flow through the duct 2 to the ink chamber 31 of the ink cartridge 3 (the ink chamber 31 constantly contains a small amount of the ink 121 to prevent the nozzle from drying and clogging. The air intake device 13 aims to balance the internal pressure of the closed container 12. Meanwhile it also controls air intake corresponding to flowing out of the ink 121 to replenish the space being voided). When the printer is not in use, the check valve 14 in the closed container 12 can prevent the ink from flowing back.

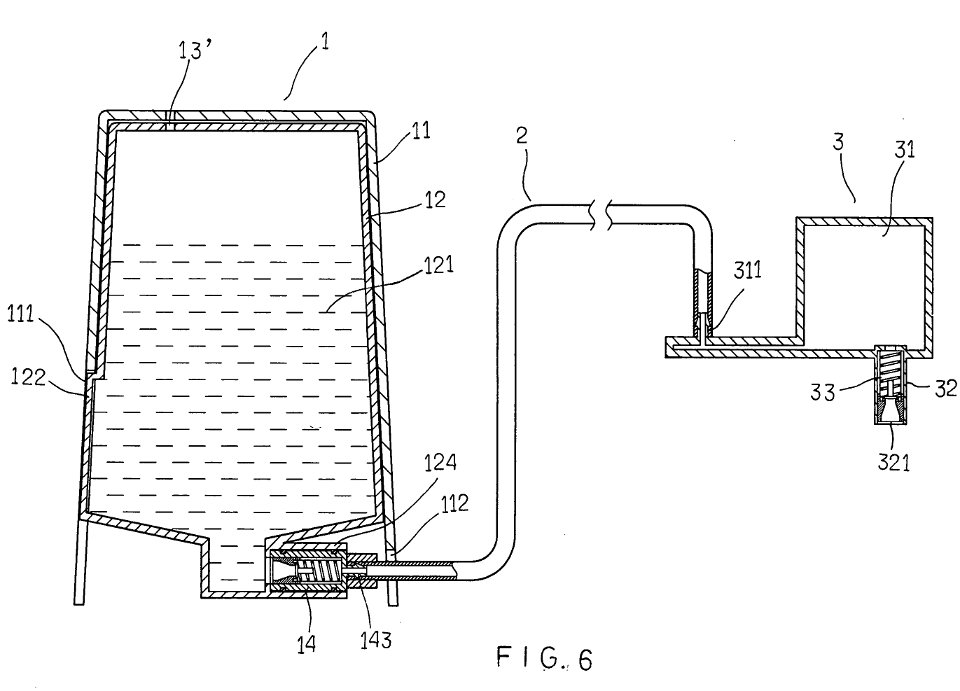

The air intake device 13 of the invention may adopt a simpler structure. Referring to FIG. 6, it may be an air inlet 13′ located on the top end of the high capacity tank 1 to allow the air to enter and replenish the air diminished due to use of the ink 121 thereby to balance the internal pressure of the closed container 12.

Moreover, the outlet of the ink outflow device 32 may be sealed by a membrane 321 to replace the check valve 33 so that the ink 121 may be prevented from flowing out before the ink cartridge 3 is installed to couple with the nozzle of the inkjet printer A.

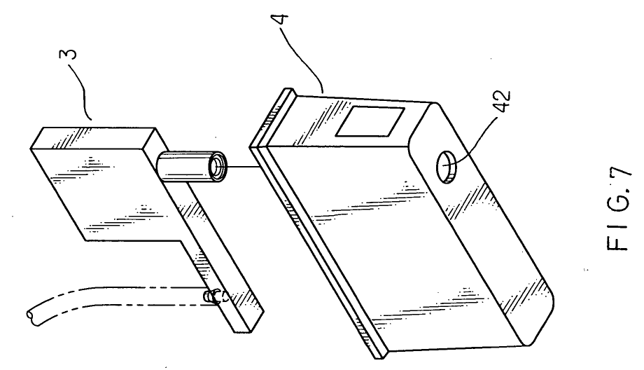

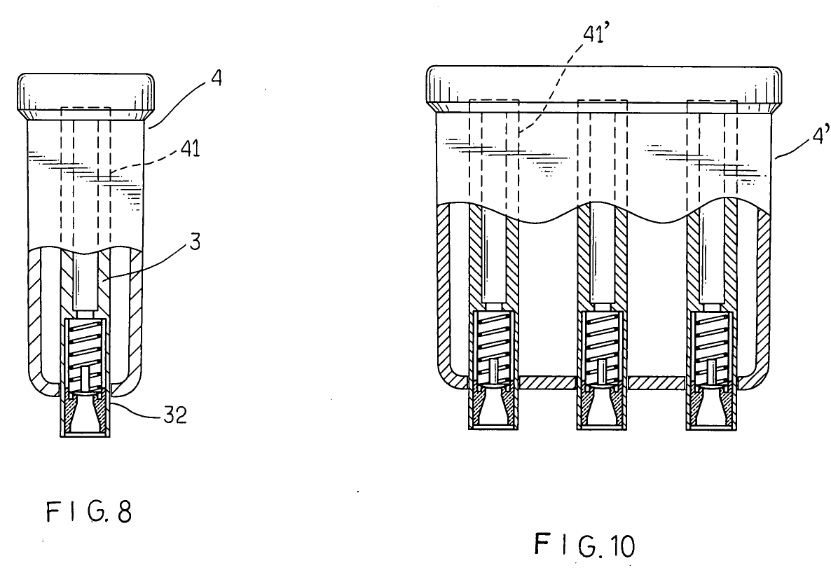

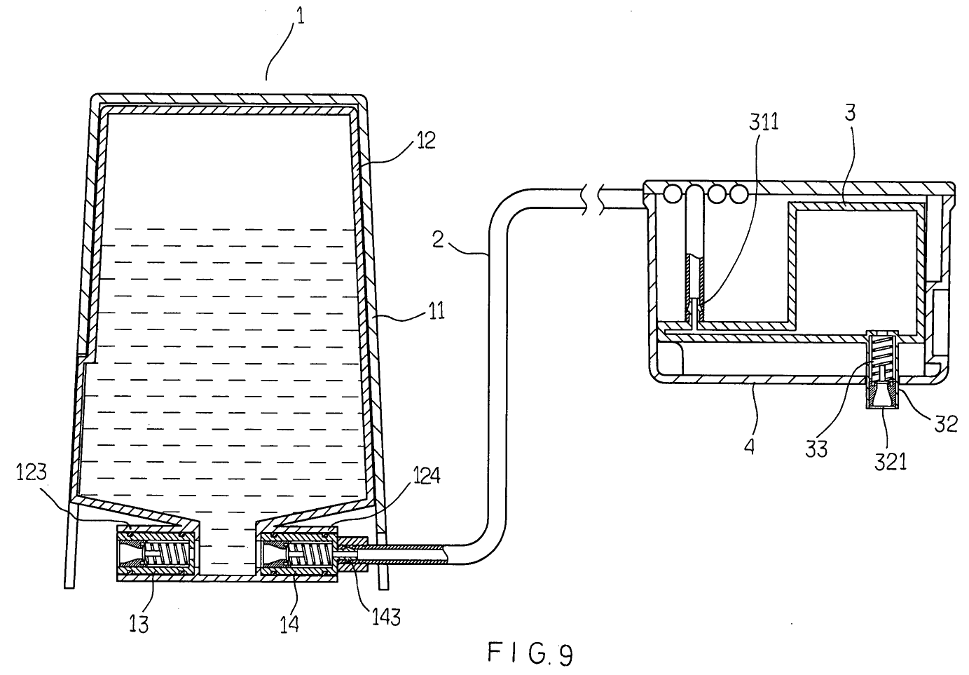

In addition (referring to FIGS. 7, 8 and 9), the ink cartridge 3 of the invention may be formed in a standard profile. And an imitated outer cartridge 4 may be made with a core trough 41 formed therein to house the ink cartridge 3. The imitated outer cartridge 4 matches the original ink cartridges of a corresponding brand. Thus only one standardized ink cartridge 3 may be fabricated. By coupling with the imitated outer cartridge 4, it can be used on the printers of different brands and vendors. Hence compatibility may be improved to reduce the production cost of the ink cartridge. The imitated outer cartridge 4 has a profile matching the original ink cartridges of a corresponding brand. It has a core trough 41 to house the standardized ink cartridge 3. It also has an aperture 42 corresponding to the ink outflow device 32 to enable the ink outflow device 32 to extend outwards. Moreover, to suit multi-color ink cartridges, the imitated outer cartridge 4′ may contain a plurality of core troughs 41′ (referring to FIG. 10) to house the standard ink cartridges of various colors.

In summary, the invention can overcome the drawbacks of insufficient ink capacity and high prices occurred to the conventional ink cartridges. The cost may be reduced, and applicability increases. While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

1. A high capacity ink supply apparatus comprising a high capacity tank, an ink cartridge and a duct bridging the high capacity tank and the ink cartridge, wherein:
the high capacity tank includes a closed container for holding ink that has an air intake device and a check valve which allows the ink to flow in one direction;
the ink cartridge is mountable in an ink cartridge housing of an inkjet printer and includes an ink chamber which has a duct connector extending from one side for connecting one end of the duct, the ink cartridge further has an ink outflow device on a lower side corresponding to a nozzle of the inkjet printer to allow the ink to flow out; and
the duct is a hollow tube.

2. The high capacity ink supply apparatus of claim 1, wherein the air intake device is a check valve located in a first dock cavity on one side of the bottom of the closed container.

3. The high capacity ink supply apparatus of claim 1, wherein the check valve has an outlet end which is coupled with another duct connector to connect another end of the duct.

4. The high capacity ink supply apparatus of claim 1, wherein the air intake device is an air inlet located on the top end of the high capacity tank.

5. The high capacity ink supply apparatus of claim 1, wherein the check valve is located in a second dock cavity on another side of the bottom of the closed container.

6. The high capacity ink supply apparatus of claim 1, wherein the ink outflow device is a check valve.

7. The high capacity ink supply apparatus of claim 1, wherein the ink outflow device has an outlet which is sealed by a membrane.

8. The high capacity ink supply apparatus of claim 1, wherein the closed container is housed in an outer casing.

9. A high capacity ink supply apparatus comprising a high capacity tank, an ink cartridge, an imitated outer cartridge, and a duct bridging the high capacity tank and the ink cartridge, wherein:
the high capacity tank includes a closed container for holding ink that has an air intake device and a check valve which allows the ink to flow in one direction;
the ink cartridge is mountable in an ink cartridge housing of an inkjet printer and includes an ink chamber which has a duct connector extending from one side for connecting one end of the duct, the ink cartridge further has an ink outflow device on a lower side corresponding to a nozzle of the inkjet printer to allow the ink to flow out;
the imitated outer cartridge is formed in a profile matching an original ink cartridge of a corresponding brand and has a core trough for housing the ink cartridge, and
the duct is a hollow tube.

10. The high capacity ink supply apparatus of claim 9, wherein the air intake device is a check valve located in a first dock cavity on one side of the bottom of the closed container.

11. The high capacity ink supply apparatus of claim 9, wherein the check valve has an outlet end which is coupled with another duct connector to connect another end of the duct.

12. The high capacity ink supply apparatus of claim 9, wherein the air intake device is an air inlet located on the top end of the high capacity tank.

13. The high capacity ink supply apparatus of claim 9, wherein the check valve is located in a second dock cavity on another side of the bottom of the closed container.

14. The high capacity ink supply apparatus of claim 9, wherein the ink outflow device is a check valve.

15. The high capacity ink supply apparatus of claim 9, wherein the ink outflow device has an outlet which is sealed by a membrane.

16. The high capacity ink supply apparatus of claim 9, wherein the closed container is housed in an outer casing.

17. The high capacity ink supply apparatus of claim 9, wherein the imitated outer cartridge has a plurality of core troughs for housing ink cartridges of multiple colors.
